(19) United States
(12) Patent Application Publication
(10) Pub. No.: US 2012/0120191 A1
(43) Pub. Date: May 17, 2012

(54) IMAGE PROCESSOR FOR USE IN A FRAME SEQUENTIAL 3D DISPLAY SYSTEM AND RELATED 3D DISPLAY SYSTEM

(76) Inventor: Hung-Chia Lee, Tainan County (TW)

(21) Appl. No.: 12/947,839

(22) Filed: Nov. 17, 2010

(51) Int. Cl. H04N 13/00

(52) U.S. Cl. 348/43; 348/E13.026; 348/E13.06

(57) ABSTRACT

A frame sequential 3D display system includes an image source, an image processor, and a display device. The image source is configured to provide a 2D video signal consisting of multiple frames for representing an image and generate an upsampled 2D video signal by increasing the frame rate of the source 2D video signal. The image processor includes an identical frame detector and a 2D/3D converter. After identify corresponding pairs of frames in the upsampled 2D video signal, the identical frame detector instructs the 2D/3D converter to convert the corresponding pairs of frames in the upsampled 2D video signal into corresponding right-eye images and corresponding left-eye images constituting a 3D video signal. The display device is configured to receive and display the 3D video signal.

### BACKGROUND OF THE INVENTION

1. Field of the Invention

The present invention is related to an image processor for use in a 3D display system and a related 3D display system, and more particularly, to an image processor for use in a frame sequential 3D display system and a related frame sequential 3D display system which performs 2D/3D conversion without using a frame buffer.

2. Description of the Prior Art

Three-dimensional (3D) display technology provides more vivid visual experiences than traditional two-dimensional (2D) display technology. In general, the stereoscopic image processing involves two camera systems in which two different images or videos are taken from slightly different camera angles and locations. Techniques to artificially create a perception of depth on a 2D surface include the use of presenting different images to the left and right eyes of the viewer. In such frame sequential 3D display system, a sequence of alternating frames wherein each successive frame carries the image meant for one or the other eye is presented to each eye using shutter glasses having a left-eye lens and a right-eye lens, each of which may be made from electronically controllable liquid crystal assemblies. The lenses are configured to be alternatively switched on and off in sync with the alternating frames such that the right eye only views the right-eye images and the left eye only views the left-eye images. The two series of images are combined by the brain in such a way to perceive depth.

Many display devices, such as televisions, have a scan rate of 60 Hz (ex. in the United States) or 50 Hz (in some countries other than the United States). In regular 2D mode, a frame sequential television displays a new image fifty or sixty times per second in order to present a dynamic video presentation to the viewer. In 3D mode, the effective refresh rate of the frame sequential television is halved since each eye needs a separate picture. For this reason, a frame sequential 3D display system needs to be able to double the frame rate of the 50/60 Hz source 2D video signal, thereby generating a corresponding 120 Hz upsampled 2D video signal, based on which a corresponding 120 Hz 3D video signal consisting of respective left-eye and right-eye images may be generated.

FIG. 1 is a functional diagram illustrating a prior art frame sequential 3D display system 100. The frame sequential 3D display system 100 includes an image source 110, an image processor 120, a frame sequential display device 130, and shutter glasses 140. The image source 110 may provide a source 2D signal S1 consisting of multiple frames representing an image. The image processor 120 includes a frame rate converter 22, a frame buffer 24, and a 2D/3D converter 26. The frame rate converter 22 is configured to increase the total number of frames in the source 2D video signal S1 by inserting new frames (interpolated frames) between two neighboring frames of the original source 2D video signal S1, thereby generating a corresponding upsampled 2D video signal S2 with a higher frame rate. According to the upsampled 2D video signal S2, the 2D/3D converter 26 may generate a corresponding 3D video signal S3 consisting of two series of alternating sequential frames, one of which corresponds to left-eye images and the other of which corresponds to right-eye images. According to the 3D video signal S3, the frame sequential display device 130 may display the right-eye and left eye images in an alternative manner and control the lenses of the shutter glasses 140 accordingly so that each eye only views the images intended for that eye.

FIG. 2 is a diagram illustrating the operation of the prior art image processor 120. Assume that the source 2D video signal S1 includes data represented by a sequence of odd-numbered frames F₁˜F_{N-1} and even-numbered frames F₂˜F_{N} (N is an even number) associated with respective left-eye and right-eye images to be presented on the frame sequential display device 130. In the prior art 3D display system 100, the frame buffer 24 is required to store the frames F₁˜F_{N} received during corresponding periods. Therefore, the frame rate converter 22 may double the frame rate of the source 2D video signal S1 by outputting each of the frames F₁˜F_{N} for two consecutives times. According to each pair of the frames F₁˜F_{N} provided in upsampled 2D video signal S2 in the sequence illustrated in FIG. 2, the 2D/3D converter 26 may convert the upsampled 2D video signal S2 into a corresponding 3D video signal S3 consisting of left-eye images L₁˜L_{N} and right-eye images R₁˜R_{N}. The operation of the two lenses of the shutter glasses 140 is illustrated by a left-eye ON signal and a right-eye ON signal.

Since the acquisition and output of frame data normally involve a temporal delay and each frame of the source 2D video signal needs to be doubled, the frame buffer 24 is required to store each frame over a period of time so that the prior art image processor 120 may output the correct data subsequently. Therefore is a need for an image processor capable of performing 2D/3D conversion without using a frame buffer.

### SUMMARY OF THE INVENTION

The present invention provides a frame sequential 3D display system an image source, an image processor, and a display device. The image source is configured to provide a source 2D video signal having a plurality of first frames for representing an image and generate an upsampled 2D video signal by increasing a frame rate of the source 2D video signal. The image processor includes a 2D/3D converter configured to receive the upsampled 2D video signal and convert the upsampled 2D video signal into a series of right-eye images and a series of left-eye images which are alternatively outputted for constituting a 3D video signal. The display device is configured to display the series of right-eye images and the series of left-eye images according to the 3D video signal.

The present invention also provides an image processor for use in a frame sequential 3D display system and including a 2D/3D converter configured to receive an upsampled 2D video signal directly from an image source and convert the upsampled 2D video signal into a series of right-eye images and a series of left-eye images which are alternatively outputted for constituting a 3D video signal, wherein a frame rate of the upsampled 2D video signal is equal to a frame rate of the 3D video signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional diagram illustrating a prior art frame sequential 3D display system.

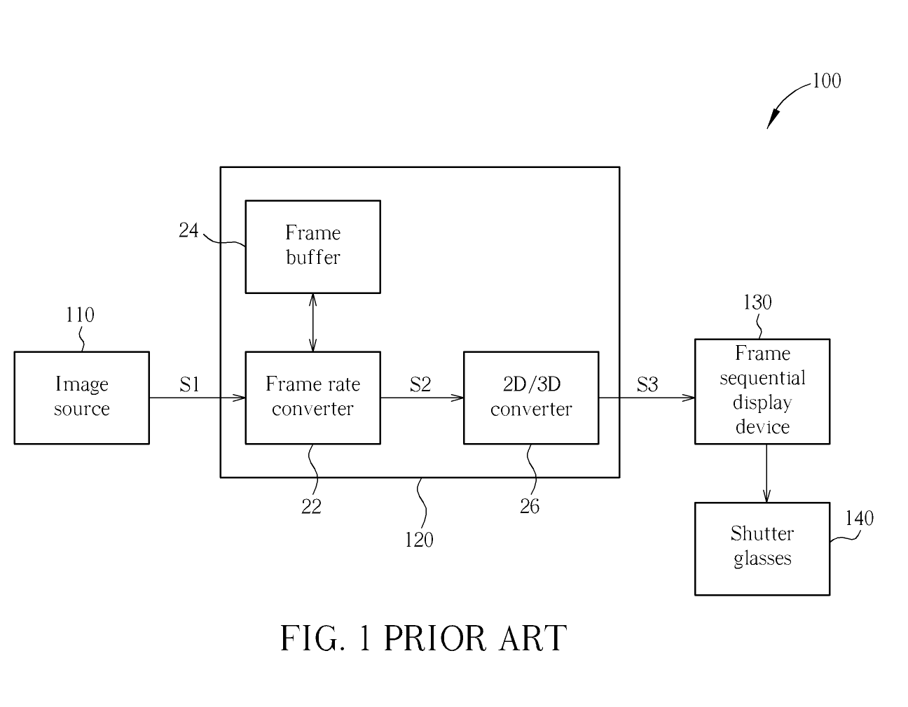

FIG. 2 is a diagram illustrating the operation of a prior art image processor.

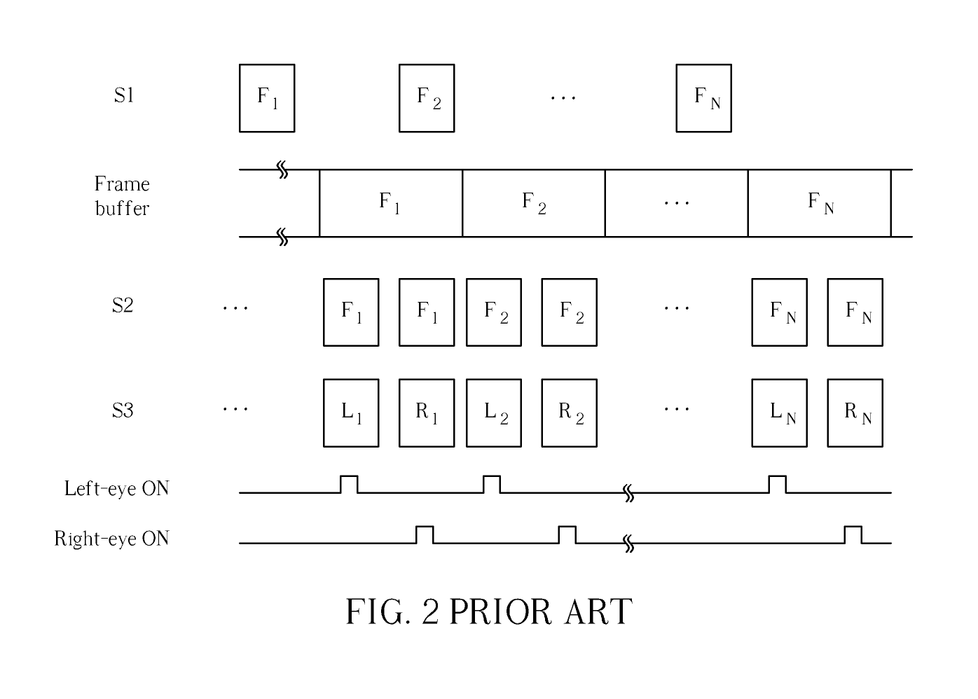

FIG. 3 is a functional diagram illustrating a frame sequential 3D display system according to a first embodiment of the present invention.

FIG. 4 is a diagram illustrating the operation of an image processor according to the present invention.

FIG. 5 is a functional diagram illustrating a frame sequential 3D display system according to a second embodiment of the present invention.

FIG. 6 is a diagram illustrating the operation of an image processor according to the present invention.

### DETAILED DESCRIPTION

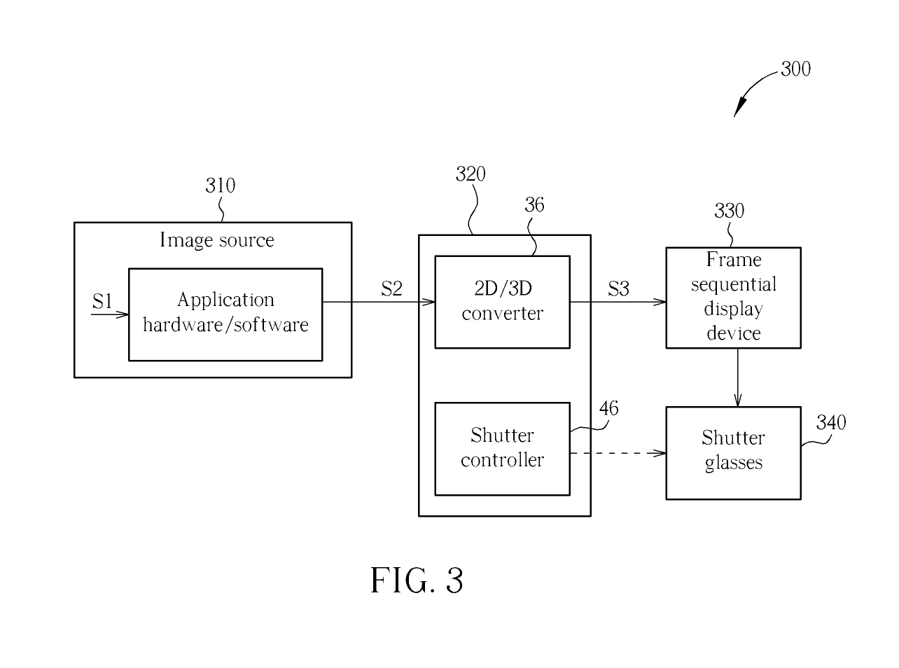

FIG. 3 is a functional diagram illustrating a frame sequential 3D display system 300 according to a first embodiment of the present invention. The frame sequential 3D display system 300 includes an image source 310, an image processor 320, a frame sequential display device 330, and shutter glasses 340. The image source 310 is configured to provide a source 2D signal S1 consisting of multiple frames representing an image and generate a corresponding upsampled 2D video signal S2 by doubling the frame rate of the source 2D video signal S1. The image processor 320 includes a 2D/3D converter 36 and a shutter controller 46. The 2D/3D converter 36 is configured to generate a corresponding 3D video signal S3 consisting of two series of alternating sequential frames, one of which corresponds to left-eye images and the other of which corresponds to right-eye images. According to the 3D video signal S3, the frame sequential display device 330 may display the right-eye and left eye images in an alternative manner, and the shutter controller 46 may operate the lenses of the shutter glasses 340 in sync with respective left-eye and right-eye images so that each eye only views the images intended for that eye.

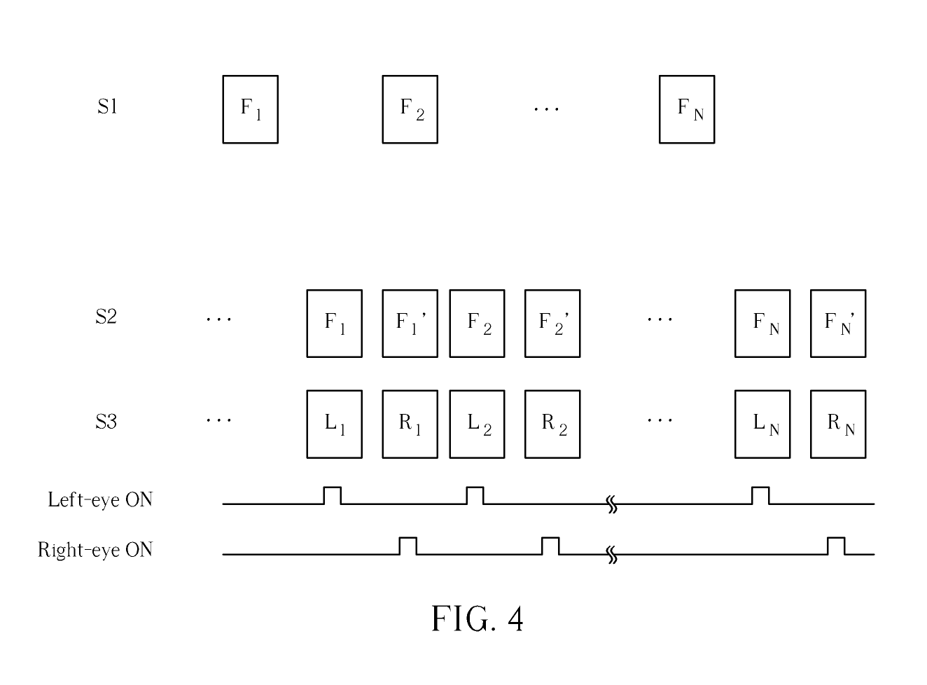

FIG. 4 is a diagram illustrating the operation of the image processor 320 according to the present invention. Assume that the source 2D video signal S1 includes data represented by a sequence of odd-numbered frames F₁˜F_{N-1} and even-numbered frames F₂˜F_{N} (N is an positive even integer) associated with respective left-eye and right-eye images to be presented on the frame sequential display device 330. In the frame sequential 3D display system 300 of the present invention, the image source 310 is configured to generate the upsampled 2D video signal S2 by inserting interpolated frames F₁′-Fₙ′, which are respectively generated according to the frames F₁˜Fₙ, into the original source 2D video signal S1. The upsampled 2D video signal S2 is provided by outputting the frames F₁, F₁′, F₂, F₂′, . . . , Fₙ and Fₙ′ in the sequence illustrated in FIG. 4. In one embodiment of the present invention, the video information of the interpolated frames F₁′-Fₙ′ may be identical copies of the original frames Fₗ-Fₙ, respectively. In another embodiment of the present invention, several techniques may be employed when generating the interpolated frames F₁′-Fₙ′ according to the corresponding frames F₁-Fₙ in order to enhance the quality of the upsampled 2D video signal S2, such as an adaptive artifact masking technique which makes artifacts less noticeable for eyes, a black stripe processing technique which removes black stripes commonly present near frame edges of the interpolated frames, or an occlusion tracking technique which performs high quality restoration of interpolated frames near edges in case of presence of motion with direction to/from the frame edge. Meanwhile, the operation of the two lenses of the shutter glasses 340 is illustrated by a left-eye ON signal and a right-eye ON signal.

In the frame sequential 3D display system 300 according to the first embodiment of the present invention, the video signals S1-S3 may be analog video signals in the NTSC or PAL formats, or in other analog and digital signal formats well-known to those persons having ordinary skill in the art. The image source 310 may include any electronic appliances installed with application hardware (such as a graphic card) which may support various FPS (frames per second) settings, or application software (such as Media Player) which may playback images in various modes. Since the image source 310 is configured to perform signal upsampling, the image processor 320 of the present invention may perform 2D/3D conversion directly according to the upsampled 2D video signal S2 received from the image source 310 without using a frame buffer.

As illustrated, up-sampling is performed by the image source 310 and 2D/3D format conversion is performed by the image processor 320 in the present invention. Regarding two consecutive frames in the upsampled 2D video signal S2, they may be two corresponding frames based on which a corresponding pair of left-eye and right-eye images are generated (such as the frames F₁ and F₁′ based on which the corresponding images L₁ and R₁ are generated), or two frames based on which a left-eye image in a certain pair of left-eye and right-eye images and a right-eye image in another pair of left-eye and right-eye images are generated (such as the frames F₁′ and F₂ based on which the images R₁ and L₂ are generated). Therefore, there is a need to identify the relationship between two consecutive frames in the upsampled 2D video signal S2 in order to guarantee the synchronization between the operation of the shutter glasses 340 and the 3D video signal S3.

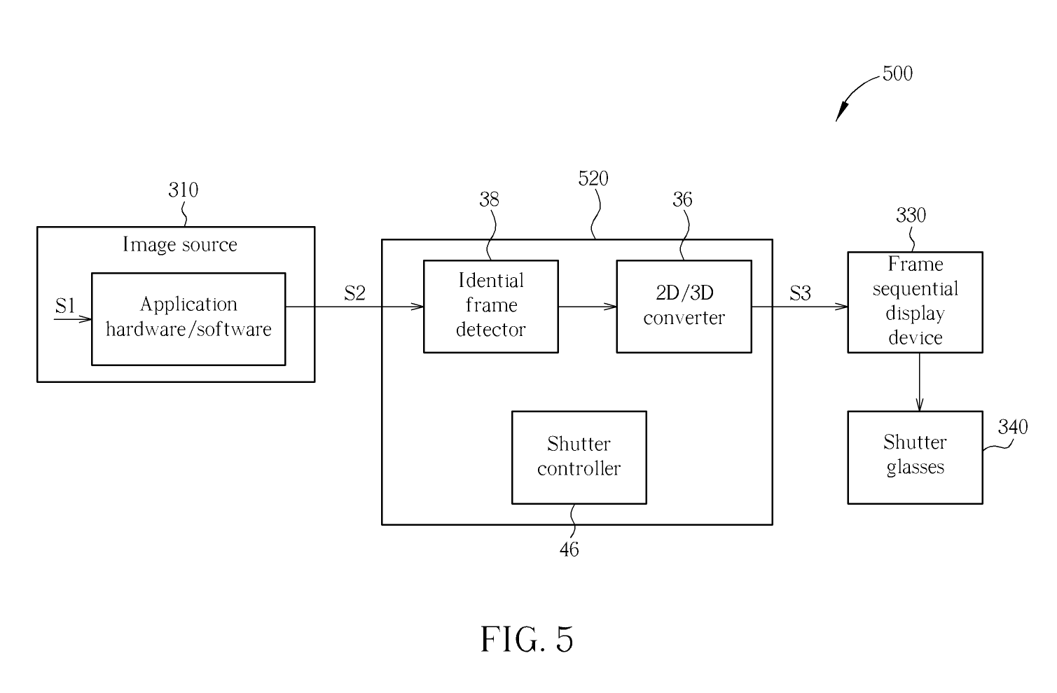

FIG. 5 is a functional diagram illustrating a frame sequential 3D display system 500 according to a second embodiment of the present invention. The frame sequential 3D display system 500 includes an image source 310, an image processor 520, and a frame sequential display device 330. Similar to the frame sequential 3D display system 300 according to the first embodiment of the present invention, the image processor 520 of the frame sequential 3D display system 500 further includes an identical frame detector 38. The identical frame detector 38 is configured to analyze the image characteristics of the frames F₁-Fₙ and F₁′-Fₙ′ for a predetermined period of time, thereby identifying the corresponding frame pairs in the upsampled 2D video signal S2. Next, the identical frame detector 38 may instruct the 2D/3D converter 36 to begin format conversion and the shutter controller 46 may operate the lenses of the shutter glasses 340 in sync with respective left-eye and right-eye images.

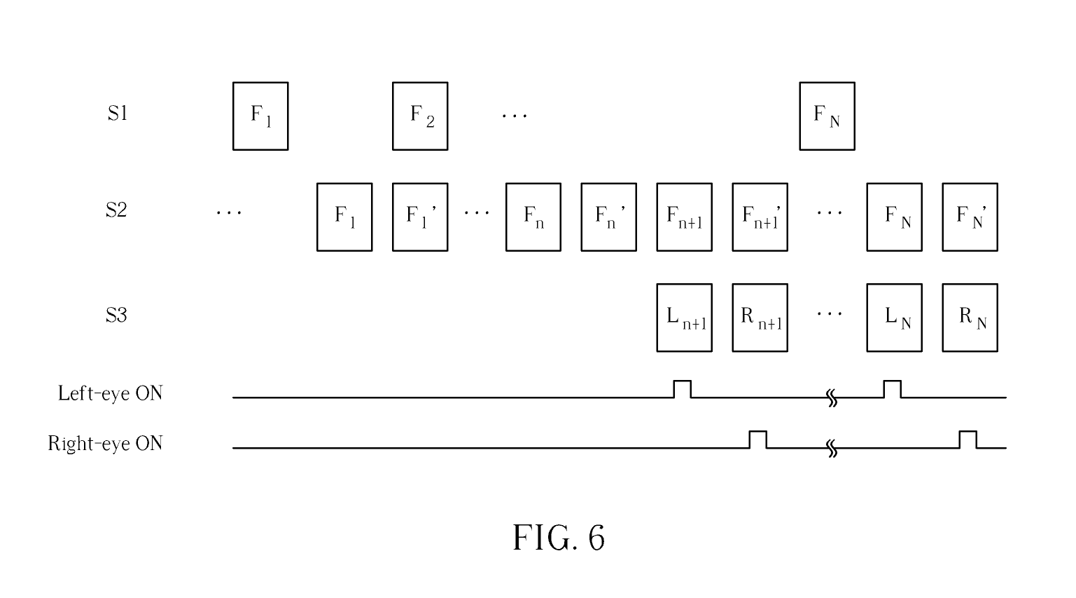

FIG. 6 is a diagram illustrating the operation of the image processor 520 according to the present invention. The identical frame detector 38 may perform image analysis on the upsampled 2D video signal S2 for a predetermined period of time, such as on the first n frame pairs F₁, F₁′, F₂, F₂′, . . . , Fₙ, Fₙ′ (n is an integer smaller than N) for identifying the corresponding frame pairs based on checksum or histogram of the frames F₁-Fₙ and F₁′-Fₙ′, or based on other image characteristics well-known to those skilled in the art. For any three consecutive frames such as F₁, F₁′, and F₂ in the upsampled 2D video signal S2, the image characteristic of the frame F₁′ is identical or slightly different than that of the frame F₁ since the frame F₁′ is an interpolated frame generated by the image source 310 according to the frame F₁ of the source 2D video signal S1, but differs from that of the frame F₂ since the frames F₁′ and F₂ are generated by the image source 310 according to two different frames F₁ and F₂ of the source 2D video signal S1. Therefore, if two consecutive frames in the upsampled 2D video signal S2 have identical or slightly different image characteristics, they may be identified as a corresponding frame pair. Next, the 2D/3D converter 36 may thus perform 2D/3D conversion on the frames Fₙ₊₁-F_{N}′ and the shutter controller 46 may switch on/off the lenses of the shutter glasses 340 in an alternative fashion (as illustrated by a left-eye ON signal and a right-eye ON signal in FIG. 6) when respective left-eye and right-eye images are outputted.

In one embodiment of FIG. 6, only three consecutive frames such as F₁, F₁′, and F₂ in the upsampled 2D video signal S2 are required for identifying the corresponding frame pairs. In another embodiment of FIG. 6, more consecutive frames such as F₁, F₁′, F₂, F₂′, . . . , Fₙ, Fₙ′ in the upsampled 2D video signal S2 may be used for identifying the corresponding frame pairs so as to achieve better accuracy.

The present invention may be applied to a glass-type frame sequential 3D display system which requires shutter glasses for creating stereoscopic effect, as depicted in FIGS. 3-6. However, the present invention may also be applied to other types of frame sequential 3D display system, such as a naked-eye directional backlight time sequential 3D display system or a time-multiplexed polarizer 3D projector.

In the frame sequential 3D display system of the present invention, up-sampling is performed by the image source. The image processor may thus perform 2D/3D conversion directly according to the upsampled signal received from the image source without using a frame buffer.

Those skilled in the art will readily observe that numerous modifications and alterations of the device and method may be made while retaining the teachings of the invention.

What is claimed is:

1. A frame sequential three-dimensional (3D) display system, comprising:
an image source configured to provide a source two-dimensional (2D) video signal having a plurality of first frames for representing an image and generate an upsampled 2D video signal by increasing a frame rate of the source 2D video signal;
an image processor comprising a 2D/3D converter configured to receive the upsampled 2D video signal and convert the upsampled 2D video signal into a series of right-eye images and a series of left-eye images which are alternatively outputted for constituting a 3D video signal; and
a display device configured to display the series of right-eye images and the series of left-eye images according to the 3D video signal.

2. The frame sequential 3D display system of claim 1, wherein the image source is further configured to provide a plurality of second frames associated with the plurality of first frames and generate the upsampled 2D video signal by interpolating each second frame between two corresponding first frames.

3. The frame sequential 3D display system of claim 1, wherein the image processor further comprises an identical frame detector configured to identify a corresponding pair of frames in the upsampled 2D video signal and instruct the 2D/3D converter to convert the corresponding pair of frames of the upsampled 2D video signal into a corresponding right-eye image and a corresponding left-eye image of the 3D video signal.

4. The frame sequential 3D display system of claim 3, wherein the identical frame detector is configured to identify the corresponding pair of frames in the upsampled 2D video signal by comparing image characteristics of three consecutive frames in the upsampled 2D video signal.

5. The frame sequential 3D display system of claim 3, wherein the identical frame detector is configured to identify the corresponding pair of frames in the upsampled 2D video signal by comparing image characteristics of n consecutive frames in the upsampled 2D video signal, wherein n is an integer larger than 3.

6. The frame sequential 3D display system of claim 3, further comprising shutter glasses including an electronically controllable right-eye lens and an electronically controllable left-eye lens, wherein the right-eye lens is switched on and the left-eye lens is switched off when the corresponding right-eye image is displayed, and the left-eye lens is switched on and the right-eye lens is switched off when the corresponding left-eye image is displayed.

7. An image processor for use in a frame sequential 3D display system, comprising:
a 2D/3D converter configured to receive an upsampled 2D video signal directly from an image source and convert the upsampled 2D video signal into a series of right-eye images and a series of left-eye images which are alternatively outputted for constituting a 3D video signal, wherein a frame rate of the upsampled 2D video signal is equal to a frame rate of the 3D video signal.

8. The image processor of claim 7 further comprising:
an identical frame detector configured to identify a corresponding pair of frames in the upsampled 2D video signal and instruct the 2D/3D converter to convert the corresponding pair of frames of the upsampled 2D video signal into a corresponding right-eye image and a corresponding left-eye image of the 3D video signal.

9. The image processor of claim 8, wherein the identical frame detector is configured to identify the corresponding pair of frames in the upsampled 2D video signal by comparing image characteristics of three consecutive frames in the upsampled 2D video signal.

10. The image processor of claim 8, wherein the identical frame detector is configured to identify the corresponding pair of frames in the upsampled 2D video signal by comparing image characteristics of n consecutive frames in the upsampled 2D video signal, wherein n is an integer larger than 3.

11. The image processor of claim 8 further comprising a shutter controller configured to switch on a right-eye lens of shutter glasses and switch off a left-eye lens of the shutter glasses when the corresponding right-eye image is displayed, and configured to switch off the right-eye lens and switch on the left-eye lens when the corresponding left-eye image is displayed.
